(19) United States
(12) Patent Application Publication
(10) Pub. No.: US 2014/0268777 A1
(43) Pub. Date: Sep. 18, 2014

(54) Flexible LED Lighting Material and Frame Assembly for Use with Same

(71) Applicants: Tagir Saydkhuzhin, Miami, FL (US); Michael Raveney, Miami, FL (US); Maz Makhani, Los Angeles, CA (US); David Blue Thompson, Westlake Village, CA (US); Charlie Lenz, Culver City, CA (US)

(72) Inventors: Tagir Saydkhuzhin, Miami, FL (US); Michael Raveney, Miami, FL (US); Maz Makhani, Los Angeles, CA (US); David Blue Thompson, Westlake Village, CA (US); Charlie Lenz, Culver City, CA (US)

(21) Appl. No.: 14/213,357

(22) Filed: Mar. 14, 2014

Related U.S. Application Data
(60) Provisional application No. 61/800,982, filed on Mar. 15, 2013.

(51) Int. Cl. F21K 99/00; F21V 21/14

(52) U.S. Cl. CPC F21K 9/30; F21V 21/14
USPC 362/249.04

(57) ABSTRACT

A flexible LED lighting material and a frame assembly for use with the light material. In addition, the invention comprises a lighting device that is comprised of a flexible substrate comprising at least one fastener; at least one flexible LED light strip having LED elements and being affixed to the flexible substrate; a collapsible frame assembly to which the at least one fastener removably attaches the flexible substrate; and an electric ballast electrically connected to the at least one flexible LED light strip and, when operated, supplying power to the at least one flexible LED light strip to light at least some of the LED elements.

### CROSS-REFERENCE TO RELATED APPLICATIONS

This application claims the priority, under 35 U.S.C. §119, of U.S. Provisional Patent Application Ser. No. 61/800,982, filed on Mar. 15, 2013, the entire disclosure of which is hereby incorporated by reference in its entirety.

### FIELD OF THE INVENTION

The present invention lies in the field of lighting devices and fixtures used to illuminate a subject and/or an area. In particular, the present invention relates to a new form of LED lighting material that can be used for any general lighting purpose, but has a particular use in photography and film production settings.

### BACKGROUND OF THE INVENTION

Due to certain characteristics and qualities of lighting devices (and fixtures) used in the film and photographic industries for illuminating a subject and/or an area, these lighting devices impose several limitations that can hinder and impede the production process. For example, the lighting devices require a lot of power and generate a lot of heat, making it difficult to use the lighting devices for a prolonged period without causing discomfort and requiring fanning or air conditioning. Moreover, the power required to supply the lighting devices is a significant cost. In addition, the lighting devices are relatively large. Therefore, a significant amount of designated space is required for their use. Transportation of the lighting devices from one place to another is not easily accomplished. Accordingly, this limits the movement and angles of the camera, thereby limiting the end product as a result. Also, with respect to filming, the time needed to switch a lighting element of the device from a daylight source to a tungsten source adds time to the filming process and slows its production.

Accordingly, a need exists to overcome the problems with the prior art lighting systems, designs and processes as discussed above.

### SUMMARY OF THE INVENTION

The invention provides a lighting material, comprised of light emitting diodes (LED), that overcomes the hereinafore-mentioned disadvantages of the heretofore-known devices and methods of this general type and that provide such features with an ability to illuminate a subject and/or area with greater flexibility and that would eliminate many of the limitations of prior art lighting devices. By using LEDs, a significant amount of illumination is still possible despite using less power, generating less heat, and using less space.

By way of background, in the photography and film production industries, there are devices referred to as scrims or diffusers that are used to control or adjust the quality of the light on a set. In the still and motion picture lighting industry, these devices are typically comprised of frames with diffusion cloths attached to the inside of the frame. These devices usually are found in 2′×2′, 4′×4′, and 8′×8′ feet dimensions.

The lighting material described herein is comprised of a plurality of flexible LED light strips that are attached, permanently or removably, to a flexible substrate or material to form a flexible material of light. For example, the LED light strips may be affixed to a fabric material to form a sort of cloth “rag” that can be wrapped around, attached to, or draped on many different surfaces. Because both the fabric and the LED light strips are flexible, the finished material may be wrapped around a ball and the entire ball then outwardly radiates light in a spherical shape. Moreover, as described in further detail below, this lighting material can be put into standard frames or, may be put into the frame assemblies contemplated herein, to produce a device that functions much like the scrims or diffusers used in the photography and film production industries.

Additionally, due to the modular nature of the lighting materials described herein, a number of these cloths can be placed adjacent to one another and fastened together to create a larger or distinctly shaped lighting unit. Each cloth can also be mounted directly onto a wall, like a painting, to produce light with use of a very small space. Again, the inherent flexibility of the LED light strips and the underlying substrate or material allows the finished lighting material to be easily adapted to different surfaces in a variety of ways to dynamically create a lighting element or device that is easily portable and adjustable such that it may be configured for use in many different environments and circumstances.

With the foregoing and other objects in view, there is provided, in accordance with the present invention, a lighting material, comprising a flexible substrate comprising at least one fastener shaped to removably attach the flexible substrate to a surface of the environment, at least one flexible LED light strip having LED elements and being affixed to the flexible substrate, and an electric ballast electrically connected to the at least one flexible LED light strip and, when operated, supplying power to the at least one flexible LED light strip to light at least some of the LED elements.

In accordance with another mode of the invention, a plurality of the flexible LED light strips are affixed to the flexible substrate adjacent to one another.

In accordance with a further mode of the invention, the at least one flexible LED light strip is removably affixed to the flexible substrate.

In accordance with an added mode of the invention, the flexible substrate is a first flexible substrate, and further comprising a second flexible substrate having at least one flexible LED light strip affixed thereto, the second flexible substrate further comprising at least one second fastener shaped to removably attach the second flexible substrate to the first flexible substrate.

In accordance with an additional mode of the invention, the electric ballast has an LED controller that, when operated by a user, controls characteristics of at least one of the LED elements and the flexible LED light strip.

In accordance with yet another mode of the invention, the at least one fastener removably attaches the flexible substrate to a frame assembly.

In accordance with a further mode of the invention, there is also provided a lighting device comprising the lighting material and a collapsible frame assembly to which the at least one fastener removably attaches the flexible substrate.

In accordance with another mode of the invention, the collapsible frame assembly has components adjustable to form different frame dimensions.

In accordance with an added mode of the invention, the LED elements provide light sufficient to illuminate an area of a photographic setting.

In accordance with an additional mode of the invention, the LED elements provide light sufficient to illuminate an area of a film production setting.

In accordance with yet another mode of the invention, the flexible substrate is a first flexible substrate and further comprising a second flexible substrate having at least one flexible LED light strip affixed thereto, the second flexible substrate further comprising at least one second fastener shaped to removably attach the second flexible substrate to the collapsible frame assembly.

With the objects of the invention in view, there is also provided a lighting kit, comprising at least one flexible substrate comprising at least one fastener, at least one flexible LED light strip having LED elements, fasteners shaped to removably affix the at least one flexible LED light strip to the at least one flexible substrate, a collapsible frame assembly to which the at least one fastener removably fastens the at least one flexible substrate, the collapsible frame assembly being adjustable to form different frame dimensions, and an electric ballast electrically connected to the at least one flexible LED light strip and, when operated, supplying power to the at least one flexible LED light strip to light at least some of the LED elements.

In accordance with another mode of the invention, the at least one flexible LED light strip of the lighting kit is a plurality of flexible LED light strips and the fasteners are shaped to removably affix the plurality of flexible LED light strips to the at least one flexible substrate.

In accordance with a further mode of the invention, the at least one flexible substrate of the lighting kit is a plurality of flexible substrates and the fasteners are shaped to removably affix the plurality of flexible LED light strips to the plurality of flexible substrates interchangeably.

Although the present invention is illustrated and described herein as being a flexible LED lighting material and a frame assembly for use with the light material, it is, nevertheless, not intended to be limited to the details shown because various modifications and structural changes may be made therein without departing from the spirit of the invention and within the scope and range of equivalents. Additionally, well-known elements of exemplary embodiments described herein will not be described in detail or will be omitted so as not to obscure the relevant details of the invention.

Additional advantages and other features characteristic of the systems described herein will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments described herein are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which may not be true to scale, and which, together with the detailed description below, are incorporated in and form part of the specification, serve to further illustrate various embodiments and to explain various principles and advantages all in accordance with the present invention. Advantages of embodiments described herein will be apparent from the following detailed description of the exemplary embodiments thereof, which description should be considered in conjunction with the accompanying drawings in which:

FIG. 1 is a front, elevational view of an exemplary embodiment of a lighting material and a ballast system;

FIG. 2 is a fragmentary, cross-sectional view of a portion of the lighting material of FIG. 1;

FIG. 3 is an exploded, perspective view of the lighting material of FIG. 1;

FIG. 4 is a back, elevational view of the lighting material of FIG. 1;

FIG. 5 is a front, elevational view of another exemplary embodiment of a lighting material;

FIG. 6A is a back, elevational view of the lighting material of FIG. 5;

FIG. 6B is a back, perspective view of the lighting material of FIG. 5;

FIG. 7A is a front, elevational view of an exemplary embodiment of a fabric substrate of the lighting material of FIG. 5;

FIG. 7B is a perspective view of the fabric substrate of FIG. 7A;

FIG. 8A is a back, elevational view of the fabric substrate of FIGS. 7A and 7B;

FIG. 8B is a back, elevational view of an alternative exemplary embodiment of the fabric substrate of FIGS. 7A and 7B;

FIG. 9 is an elevational view of an exemplary embodiment of an assembly of four of the fabric substrates of FIGS. 7A and 7B;

FIG. 10A is a top view of an exemplary embodiment of a light strip of the lighting material of FIG. 5;

FIG. 10B is a side, cross-sectional view of the light strip of FIG. 10A;

FIG. 11A is a side, cross-sectional view of an exemplary embodiment of the cable-to-wire connection system of the lighting material of FIG. 5;

FIG. 11B is a top view of the cable-to-wire connection system of FIG. 11A in which a series of protective covers are intact;

FIG. 11C is a top view of the cable-to-wire connection system of FIG. 11A in which a series of protective covers are removed;

FIG. 12A is a perspective view of an exemplary embodiment of an electric ballast;

FIG. 12B is a perspective view of the electric ballast of FIG. 12A in which the exterior cover is removed;

FIG. 12C is an exploded, perspective view of the electric ballast of FIGS. 12A and 12B;

FIG. 12D is an elevational view of an exemplary embodiment of a handle piece of the electric ballast of FIGS. 12A, 12B, and 12C;

FIG. 13A is a front, elevational view of an exemplary embodiment of a frame assembly;

FIG. 13B is a side view of the frame assembly of FIG. 13A;

FIG. 14A is a front, elevational view of an exemplary embodiment of a center connecting joint of the frame assembly of FIGS. 13A and 13B;

FIG. 14B is a back, elevational view of the center connecting joint of FIG. 14A;

FIG. 14C is a side view of the center connecting joint of FIGS. 14A and 14B;

FIG. 14D is a perspective view of the center connecting joint of FIGS. 14A, 14B, and 14C;

FIG. 15A is a perspective view of an alternative exemplary embodiment of a corner connecting joint of the frame assembly of FIGS. 13A and 13B; and

FIG. 15B is a front, elevational view of the corner connecting joint of FIG. 15A applied to four corners of a portion of the frame assembly of FIGS. 13A and 13B.

### DETAILED DESCRIPTION OF THE INVENTION

As required, detailed embodiments are disclosed herein; however, it is to be understood that the disclosed embodiments are merely exemplary of the invention, which can be embodied in various forms. Therefore, specific structural and functional details disclosed herein are not to be interpreted as limiting, but merely as a basis for any claims and as a representative basis for teaching one skilled in the art to variously employ the present invention in virtually any appropriately detailed structure. Further, the terms and phrases used herein are not intended to be limiting; but rather, to provide an understandable description of the invention. While the specification may conclude with claims defining the features of the invention that are regarded as novel, it is believed that the invention will be better understood from a consideration of the following description in conjunction with the drawing figures, in which like reference numerals are carried forward.

Before the present invention is disclosed and described, it is to be understood that the terminology used herein is for the purpose of describing particular embodiments only and is not intended to be limiting. The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled,” as used herein, is defined as connected, although not necessarily directly, and not necessarily mechanically. Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Described now are exemplary embodiments. Alternate embodiments may be devised without departing from the spirit or the scope of the invention.

Referring now to the figures of the drawings in detail and first, particularly to FIG. 1, there is shown a flexible lighting material 1, according to an exemplary embodiment. FIG. 1 depicts a “front” view of the lighting material 1 whereby the illuminating side of the lighting material 1 is facing outward towards the viewer. In this particular embodiment, the illuminating element of the lighting material 1 is comprised of a plurality of flexible LED light strips 10. The LED light strips 10 (only a few of which are touching the reference lines) are aligned adjacent one another and affixed to an underlying substrate or material (not shown) in order to form the lighting material 1. The LED elements of the LED light strips 10 may be of any suitable type. For example, in a preferred embodiment, the LED elements may have a color correct adjustability in the range of between 2700 and 7200 Kelvin. To supply power to the LED light strips 10 and to provide the ability to control various functions of the LED light strips 10, an electric ballast system 20 is electrically connected to the lighting material 1.

The LED light strips 10 may be affixed to any flexible, but durable, substrate or material of any type, size, and/or shape that is suitable for its application. Thus, the finished lighting material 1 is easily portable and flexible and, therefore, can easily be applied to and accommodate the shape of nearly any object or fixture (e.g., a window, wall, door, car, frame, column or pole, or sphere) for illuminating a desired subject or space. By way of illustration, FIG. 1 depicts the LED light strips 10 as attached to a 4-foot by 4-foot square piece of fabric material 60 (shown in detail in FIG. 2) to form a lighting cloth or “rag.” In addition, by using a flexible cloth substrate 60, the lighting material 1 can be conveniently folded, rolled, or otherwise collapsed for transport or storage when the lighting material 1 is not being used. Furthermore, to ensure that the lighting material 1 is reliable for outdoor use, the underlying material or substrate may be waterproof and/or wind resistant.

The LED light strips may be detachably or permanently affixed to the underlying material or substrate of the lighting material in a variety of different ways. For example, the LED light strips can be sewn to the substrate or permanently attached to the substrate using a strong adhesive. In the exemplary embodiment shown in FIGS. 1 to 4, the plurality of LED light strips 10 are secured or incorporated into the fabric substrate 60 itself. As shown in FIG. 2, which is a detailed cross-sectional view of the bottom left corner of the lighting material 1 of FIG. 1, the underlying fabric substrate 60 is comprised of two layers—i.e., a top layer 30 and a bottom layer 40. The electrical wiring 50 that runs between the plurality of LED light strips 10 is interposed between the two layers 30, 40 such that the LED light strips 10 are integrally secured between the two layers. In essence, the LED wiring 50 is embedded between the two fabric layers. This configuration also serves to protect the structural integrity of the LED wiring 50 by shielding the wiring from exposure. Also, because the LED wiring 50 is hidden from view, it does not detract from the appearance of the lighting material 1.

In FIGS. 5, 6A-B, 7A-B, 8A-B, 9, 10A-B, and 11A-C, there is depicted another exemplary embodiment of LED light strips 235 that are removably secured to an underlying substrate material 260 to form a flexible lighting material 260. FIG. 5 provides the “front” view of the finished lighting material 200 in which the illuminating side is facing the viewer. In this exemplary embodiment, the LED light strips 235 are comprised of individual LED elements 205 that reside on a base strip 210. FIGS. 10A and 10B show in closer detail a single LED light strip 235 in top and cross-sectional views, respectively. In general, the base strips 210 may be comprised of any flexible, semi-flexible and/or semi-rigid material that is suitable for its application. For example, the base strips 210 may be comprised of a flat aluminum sheeting material and each LED element 205 may be soldered to the aluminum sheeting to form a modular illuminated array of LEDs.

FIGS. 7A and 7B depict an exemplary embodiment of the substrate material 260 as it appears apart from any other element of lighting material 200. The substrate material 260 may be comprised of any flexible, but durable, substrate or material of any type, size, and/or shape that is suitable for its application. To construct the lighting material 200, each LED light strip 235 is secured to a surface of the substrate material 260. For example, in the exemplary embodiment of FIG. 5, each LED light strip 235 is removably secured to the substrate 260 by inserting the LED light strip 235 into one or more grip structures 255 that are attached to the substrate material 260. Each grip structure 255 is shaped to receive and to hold an LED light strip 235 within its grasp. The grip structures 255 may be secured to the substrate 260 by, for example, one or more rivets 265. In this particular embodiment of FIG. 5, the rivets 265 are visible from the “back” side of the substrate material 260 as depicted in FIGS. 6A, 6B, 8A and 8B.

Advantageously, a theoretically unlimited number of these flexible LED lighting materials can be temporarily or permanently fastened side-by-side to each other to expand the dimension and scope of the lighting material in an unlimited manner. Any suitable fastener or other connecting measures can be used to interconnect the lighting materials to each other. For example, as shown in the exemplary embodiment of FIGS. 1 to 4, each lighting material 1 may be provided with a zipper 80 along one or more of its edges or borders. The zipper 80 is configured to mate with a corresponding zipper configuration of another lighting material 1. In another example, also shown in FIGS. 1 to 4, grommets 90 may be strategically applied to the corners and along the outside borders of the substrate material 60. Thereafter, ties 70 may be inserted through the grommets 90 and tied to corresponding other ties 70 or to empty grommets 90 of the neighboring lighting materials 1.

Furthermore, a myriad of ways of temporarily attaching the individual lighting materials to the surface of an object, fixture, and/or frame are contemplated herein and will ultimately depend on the type of surface to which the lighting material is being attached. For example, in the event of a relatively flat surface, suction cups or snaps can be used to attach the lighting material thereto. In the exemplary embodiment illustrated in FIGS. 1 to 4, the ties 70 (described above) that are anchored by the grommets 90 can be used to tie and secure the lighting material 1 around an object, such as a frame, rod, pole, column, ball, or tree, etc.

In another example, best shown in FIG. 4, one or more hook-and-loop fasteners 100 (e.g., Velcro®) may be applied to strategic spots along the back of the substrate material 60. Each fastener 100 is comprised of two opposing hook-and-loop sub-sheets 110, 120 that correspondingly fasten to each other when their fastener-covered sides contact each other. One of the sub-sheets 110 is attached to the back of the substrate material 60 and is connected to its corresponding sub-sheet 120 along a central seam 150. Because the sub-sheet 120 is not attached to the substrate material 60, but rather is freely hanging from the central seam 150 (see its position at reference 130), it has the freedom to be folded back along the central seam 150 such that its fastener-covered side contacts the fastener-covered side of the sub-sheet 110, thereby causing the two sub-sheets 110, 120 to form a “clamp.” Reference 140 shows this “clamp” in an open configuration and reference 130 shows this “clamp” in a closed configuration. These “clamps” may be used to attach the lighting material 1 to any object that will fit therebetween. In addition, if left in their open configurations 140, the fasteners 100 may be used to attach to the similarly open fasteners 100 of neighboring lighting materials 1 in order to attach the individual lighting materials 1 side-by-side when desired. In the exemplary embodiment of the lighting material 200 shown in FIG. 5, hook-and-loop fasteners 300 are also employed and may be attached to the substrate material 260 in the form of sub-sheets as described above or, as shown in FIGS. 7A and 7B, the substrate material 260 itself may be constructed to have one or more tabs 310 that extend outward from the edges or borders, in which case and the hook-and-loop fasteners 300 may be incorporated into the tabs 310.

To specifically adapt the flexible LED lighting material to the film and photographic industries, the lighting material may be provided as part of an assembly kit (or product) for constructing a scrim or diffuser as used in the art. Along with one or more of the lighting materials, this inventive kit also contains one or more collapsible frame assemblies that can be built to different dimensions ranging from, for example, 1-feet by 2-feet, 2-feet by 2-feet, 2-feet by 4-feet, to 4-feet by 4-feet. Each collapsible frame assembly may be specifically designed to be used with the lighting material (e.g., the frame's dimensions or any fastening measures that correspond or mate to the fasteners of the lighting material). To construct the scrim or diffuser, the collapsed frame is built to the desired size and one or more of the lighting materials is affixed to the frame using, for example, snaps, any of the attachment methods described above (and shown in FIGS. 1-4 and 5), or by any other type of suitable fastener. In addition, aircraft-type pins may be included in the assembly kit. These pins are affixed to the frame and extend outwards from the front of the frame so that diffusion cloths (or rags) may be attached to the pins for further adjustment of the quality of the light emanating from the lighting material. Alternatively, or in addition to the pins, the assembly kit may be provided with a set of adjustable doors that can be affixed to and extend outwards from the front of the frame to also control the light or attach diffusion to.

FIGS. 13A and 13B illustrate just one exemplary embodiment of a collapsible frame assembly 350 that can be used in conjunction with the LED lighting material 1. This collapsible frame assembly 350 is comprised of a number of modular parts that include, for example, a plurality of frame supports 320 that are detachably interconnected to one another by one or more connecting joints 330, 340 to form a finished frame structure. Each of the frame supports 320 may be comprised of any relatively lightweight, yet sturdy and self-supporting material suitable for its application (e.g., can be easily handled and transported by a user). For example, the frame supports 320 may be comprised of an aluminum extrusion or carbon fiber piping. Furthermore, all of the frame supports 320 of the collapsible frame assembly 350 may be identical in dimension (as shown in FIGS. 13A and 13B) or, the frame supports 320 may differ between one another in their respective dimensions. In either case, the collapsible frame assembly 350 provides the ability to build a frame structure to a number of different dimensions based upon how many of the frame supports 320 are used and the manner in which they are connected together using the one or more connecting joints 330, 340. Once a frame structure is built, it can easily be adjusted in shape or size, or completely collapsed, by disconnecting one or a number of the frame supports 320 from the frame structure. In the exemplary embodiment shown in FIGS. 13A and 13B, the collapsible frame assembly 350 is comprised of twelve 1-foot long frame supports 320 that are interconnected to form a single 4-foot by 4-foot square frame structure that has four 1-foot by 1-foot quadrant sections. At the four corners and exterior sides of the frame structure, the frame supports 320 are interconnected by inserting the ends of the frame supports into T-shaped connecting joints 340. At the center of the frame structure, four frame supports 320 are inserted into a cross-shaped connecting joint 330. FIGS. 14A, 14B, 14C, and 14D, show an exemplary embodiment of a connecting joint 330 that is a shaped to interconnect two to four frame supports 320. FIG. 15A illustrates an alternative exemplary embodiment of a T-shaped connecting joint 360 that can be used to interconnect two or three frame supports 320. FIG. 15B depicts how this particular connecting joint 360 of the exemplary embodiment of FIG. 15A functions to interconnect the frame supports 320.

Once a frame structure is built from the collapsible frame assembly 350, the LED lighting material may be temporarily attached to the frame structure using any suitable type of attachment mechanism, including the various types described above. For example, in the exemplary embodiment shown in FIGS. 5, 6A, and 6B, the LED lighting material 200 is attached to the frame supports 320 using a series of hook-and-loop fasteners 300 that have been wrapped around the circumference of the frame supports 320.

As mentioned above, to supply electrical power to the one or more LED light strips of the lighting material, a ballast system 20 is provided. As depicted in FIG. 1, the ballast system 20 is comprised of a connector 15, an electric ballast 35, and at least one wire or cable 25 connecting the ballast 35 to the connector 15. The connector 15 connects the electric ballast 35 to a central extension or a master wire 45 that connects to all of the electrical LED wiring 50 of the LED light strips 10. In the exemplary embodiment of FIG. 5, a cable-to-wire connection system is used to connect each LED element 205 of each LED light strip 235 of the lighting material 200 to a central extension or master wire 245. Specifically, as shown in detail in the exemplary embodiment of FIGS. 10A and 10B, each LED light strip 235 is provided with an electrical connector 275 at one edge of the LED light strip 235. The LED wiring (not shown) of each LED element 205 is wired to one or more electrical contacts 285 of the electrical connector 275. The electrical contacts 285 of each electrical connector 275 are electrically connected to a central extension or master wire 245, which connects to a connector 215. The connector 215 connects the central extension or master wire 245 to an electric ballast 35. This cable-to-wire connection system is shown in detail in FIGS. 11A to 11C. In FIG. 11C, there is shown a series of six separate electrical connectors 275 of six individual LED light strips that have been electrically coupled to a central extension or master wire 245. In FIGS. 11A and 11B, one or more protective covers 295 have been applied to the LED light strip 235 to shield the exposed electrical contacts 285 and protect the structural and electrical integrity of the electrical contacts 285.

FIGS. 12A, 12B, and 12C depict an exemplary embodiment of the electric ballast 35. To increase its portability, the electric ballast 35 may be fitted with a handle 400 such that the electric ballast can be easily handled and carried. In addition, the handle 400 may be shaped to hang on a fixed, or otherwise sturdy, object that is nearby the lighting material 1 to place the electric ballast within the easy reach or close proximity of the user and to prevent the electric ballast from dragging downward from the lighting material 1. In FIG. 12D, there is shown an exemplary embodiment of a handle 400 in which a notch 410 has been incorporated into the interior side of the handle 400 in order that it may securely be hung onto another object.

The electric ballast 35 not only supplies electrical power to the lighting material, but can also be configured to control a variety of functions of the lighting material. For example, the electric ballast 35 may comprise control circuitry that provides the ability to control and adjust the color temperature and light intensity of the LED elements of the LED light strips. In another example, the electric ballast 35 may be able to intelligently determine when a malfunction (e.g., a burnout) occurs in one or more of the LED elements or LED light strips and automatically cease the flow of electrical power to that particular LED element and/or LED light strip and/or automatically adjust the direction of flow and/or the amount of electrical power that is being supplied to the working LED elements and/or LED light strips to protect the working LED elements and/or LED light strips from being damaged due to the malfunction. In addition, control circuitry may be incorporated into the electric ballast 35 to allow a user to manually operate one or more switches to adjust certain parameters or characteristics of the LED elements by using a control device that is hardwired to the lighting material 1 with a control cable (not shown). Alternatively, wireless functions may be incorporated into the electric ballast 35 that would allow the user to remotely transmit control signals (e.g., via Wi-Fi or DMX) from a remote console (not shown).

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The phrase “at least one of A and B” is used herein and/or in the following claims, where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A lighting material, comprising:
a flexible substrate comprising at least one fastener shaped to removably attach the flexible substrate to a surface of the environment;
at least one flexible LED light strip having LED elements and being affixed to the flexible substrate; and
an electric ballast electrically connected to the at least one flexible LED light strip and, when operated, supplying power to the at least one flexible LED light strip to light at least some of the LED elements.

2. The lighting material according to claim 1, wherein a plurality of the flexible LED light strips are affixed to the flexible substrate adjacent to one another.

3. The lighting material according to claim 1, wherein the at least one flexible LED light strip is removably affixed to the flexible substrate.

4. The lighting material according to claim 1, wherein the flexible substrate is a first flexible substrate, and further comprising a second flexible substrate having at least one flexible LED light strip affixed thereto, the second flexible substrate further comprising at least one second fastener shaped to removably attach the second flexible substrate to the first flexible substrate.

5. The lighting material according to claim 1, wherein the electric ballast has an LED controller that, when operated by a user, controls characteristics of at least one of:
the LED elements; and
the flexible LED light strip.

6. The lighting material of claim 1, wherein the at least one fastener removably attaches the flexible substrate to a frame assembly.

7. A lighting device, comprising:
the lighting material of claim 1; and
a collapsible frame assembly to which the at least one fastener removably attaches the flexible substrate.

8. The lighting device according to claim 7, wherein the collapsible frame assembly has components adjustable to form different frame dimensions.

9. The lighting device according to claim 7, wherein the LED elements provide light sufficient to illuminate an area of a photographic setting.

10. The lighting device according to claim 7, wherein the LED elements provide light sufficient to illuminate an area of a film production setting.

11. A lighting device, comprising:
a flexible substrate comprising at least one fastener;
at least one flexible LED light strip having LED elements and being affixed to the flexible substrate;
a collapsible frame assembly to which the at least one fastener removably attaches the flexible substrate; and
an electric ballast electrically connected to the at least one flexible LED light strip and, when operated, supplying power to the at least one flexible LED light strip to light at least some of the LED elements.

12. The lighting device according to claim 11, wherein a plurality of the flexible LED light strips are affixed to the flexible substrate adjacent to one another.

13. The lighting device according to claim 11, wherein the at least one flexible LED light strip is removably affixed to the flexible substrate.

14. The lighting device according to claim 11, wherein the flexible substrate is a first flexible substrate, and further comprising a second flexible substrate having at least one flexible LED light strip affixed thereto, the second flexible substrate further comprising at least one second fastener shaped to removably attach the second flexible substrate to the first flexible substrate.

15. The lighting device according to claim 11, wherein the flexible substrate is a first flexible substrate and further comprising a second flexible substrate having at least one flexible LED light strip affixed thereto, the second flexible substrate further comprising at least one second fastener shaped to removably attach the second flexible substrate to the collapsible frame assembly.

16. The lighting device according to claim 11, wherein the electric ballast has an LED controller that, when operated by a user, controls characteristics of at least one of:
the LED elements; and
the flexible LED light strip.

17. The lighting device according to claim 11, wherein the collapsible frame assembly has components that are adjustable to form different frame dimensions.

18. A lighting kit, comprising:
at least one flexible substrate comprising at least one fastener;
at least one flexible LED light strip having LED elements;
fasteners shaped to removably affix the at least one flexible LED light strip to the at least one flexible substrate;
a collapsible frame assembly to which the at least one fastener removably fastens the at least one flexible substrate, the collapsible frame assembly being adjustable to form different frame dimensions; and
an electric ballast electrically connected to the at least one flexible LED light strip and, when operated, supplying power to the at least one flexible LED light strip to light at least some of the LED elements.

19. The lighting kit according to claim 18, wherein:
the at least one flexible LED light strip is a plurality of flexible LED light strips; and
the fasteners are shaped to removably affix the plurality of flexible LED light strips to the at least one flexible substrate.

20. The lighting kit according to claim 19, wherein:
the at least one flexible substrate is a plurality of flexible substrates; and
the fasteners are shaped to removably affix the plurality of flexible LED light strips to the plurality of flexible substrates interchangeably.
